(19) United States
(12) Patent Application Publication
(10) Pub. No.: US 2014/0224234 A1
(43) Pub. Date: Aug. 14, 2014

(54) TWO-STROKE AIR-POWERED ENGINE ASSEMBLY

(71) Applicants: Dengrong Zhou, Sanhe City (CN); Jian Zhou, Sanhe City (CN)

(72) Inventors: Dengrong Zhou, Sanhe City (CN); Jian Zhou, Sanhe City (CN)

(73) Assignee: Beijing Xiang Tian Huachuang Aerodynamic Force Technology Research Institute Company Limited, Beijing (CN)

(21) Appl. No.: 13/574,989

(22) PCT Filed: Mar. 26, 2012
(86) PCT No.: PCT/CN12/73001

§ 371 Date: Aug. 8, 2012

(30) Foreign Application Priority Data
Oct. 28, 2011 (CN) 201110331831.3

(51) Int. Cl. F02B 75/02

(52) U.S. Cl. CPC F02B 75/02; F02B 2075/025
USPC 123/65 V

(57) ABSTRACT

A two-stroke air-powered engine assembly uses compressed air as a power source. The two-stroke air-powered engine includes an engine body (1), a multiple-column power distributor (2), a power equipment (4), a controller system (6), an intake speed control valve (23), a high pressure gas tank set (13), a constant pressure tank (16), and an electronic control unit ECO (29).

### TECHNICAL FIELD

The invention relates to a two-stroke engine, and more particularly relates to a two-stroke air-powered engine assembly which uses compressed air as a power source.

### BACKGROUND

The engine is widely used in all walks of life. It is commonly used as an internal combustion piston engine utilizing a fuel as the power source in the modern means of transport such as cars, boats, etc. The engine utilizing fuel as the power source would discharge gas with many harmful substances to pollute the environment because of insufficient fuel combustion on one hand, and on the other hand, the fuel is extracted from petroleum, and the development and utilization of the system using the fuel engine as the power source are increasingly limited by the increasing lack of the petroleum source. So an impending problem is to develop a new, clean and pollution-free alternative energy source or decrease fuel consumption and emissions as far as possible. So the air-powered engine which uses compressed air as the power source meets the need fitly.

Guy Negre, a designer of the French company MDI, earlier studied the compressed air powered engine. He launched the first pure air-powered economy household-level sedan in 2002. It can be referred to FR2731472A1, U.S. Pat. No. 6,311,486B1 and US20070101712A1 etc. about the research on compressed air engines.

An engine operating at fuel supply mode and compressed air supply mode is disclosed in FR2731472A1. The engine uses common fuel such as gasoline or diesel oil on the highways, and when slowly moving in the urban and the suburb, the compressed air (or other pollution-free compressed gas) is injected into the combustion chamber. The engine can decrease the fuel consumption partially, but the emission problem isn't solved because of utilizing the fuel supply mode.

In order to further reduce pollution, a pure air-powered engine is disclosed in U.S. Pat. No. 6,311,486B1. This type of engine utilizes three independent chambers: an intake-compression chamber, an expansion and discharge chamber, and a constant volume combustion chamber. The intake-compression chamber is connected with the constant volume combustion chamber by a valve, and the constant volume combustion chamber is connected with the expansion and discharge chamber by a valve. One question of this engine is that the compressed air takes a long time to travel from the intake-compression chamber to the expansion and discharge chamber, so it takes a long time to obtain the power source gas for driving piston to do work. At the same time, the high pressure gas discharged from the expansion and discharge chamber is not used, so the operation efficiency and the continuous working period for one charge of the engine are limited.

The research on the domestic compressed air engine is in late start. The current study is mostly in a theoretical study and conceptual design phase and failed to solve the compressed air emissions and the high-pressure compressed air control and distribution problems. There is still a long way to go for a product process of the compressed air engine.

An air-powered engine assembly used in a vehicle is disclosed in the patent document CN101413403A (the family PCT application is WO2010051668A1) of the present applicant. This engine includes a gas tank, an air distributor, an engine body, a linkage device, a clutch, an automatic transmission, a differential mechanism and an impeller generator placed in the discharge chamber. This engine utilizes the compressed air to do work without any fuel, so no exhaust gas is discharged, and the “zero emission” is achieved. The exhaust gas is used repeatedly to generate electricity, so it can save the energy source and reduce the cost. But the engine is based on the traditional four-stroke engine, and when the crankshaft rotates through 720 degrees, the piston does work once. The high pressure air used as the power source can push the piston to do work when entering the cylinder, and then discharge, i.e., the strokes of the compressed air engine are an intake-expansion stroke and a discharge stroke actually. Obviously, the four-stroke engine disclosed in the patent document CN101413403A greatly wastes the effective working stroke, and the efficiency of the engine is limited. And the exhaust gas of the engine can't be recycled and utilized well, and it needs a large enough gas tank to store the high pressure air for working a long time.

An object of the invention is to provide a two-stroke air-powered engine. The invention is aimed at addressing an effectively acting problem of the compressed engine in order to achieve a new compressed air engine with economy, efficiency and zero-emissions.

### SUMMARY OF THE INVENTION

Some embodiments within the original scope of the present invention are described as following. These embodiments do not limit the requested scope of protection but provide a brief summary of more possible forms of this invention. Actually, the present invention can involve different forms which are similar or different with the following embodiments.

In accordance with one aspect of the present invention, an air-powered engine assembly is provided, which includes an engine body. The engine body includes a cylinder, a cylinder head system, an intake pipeline, a discharge pipeline, a piston, a connecting rod, a crankshaft, a discharge camshaft, an intake camshaft, a front gear box system and a back gear box. The said piston is connected to the crankshaft via the connecting rod. Said front gear box system is adapted to transmit the movement of the crankshaft and the camshaft. An air throat hole for the compressed air intake and a discharge hole for the exhaust gas discharge are placed on the said cylinder head system. The air-powered engine assembly also includes a high pressure gas tank set which is connected to an external charge device via a pipeline and a constant pressure tank which is connected to the high pressure gas tank set via a pipeline. Wherein the said air-powered engine assembly also includes an intake speed control valve which is communicated with the constant pressure tank via a pipeline, a controller system, and an electronic control unit ECO which controls the intake speed control valve on the basis of the detected signal of a sensor. The said front gear box system includes a polygonal cover, transmission gear, crankshaft gear, gear idle, intake camshaft gear, and discharge camshaft gear. The movement from the crankshaft is transmitted by the crankshaft gear through the gear idle to the intake camshaft gear which drives the intake camshaft and the discharge camshaft gear which drives the discharge camshaft.

In an exemplary embodiment, the said engine assembly further includes a multiple-column power distributor. The said multiple-column power distributor includes five stages, and it is made up of a first stage, a second stage, a third stage, a fourth stage and a fifth stage. Each stage includes an inner gear ring, a planetary gear and a sun gear. The multiple-column power distributor can effectively realize that the multi-stage output power of the engine can be distributed according to the requirement. The said intake speed control valve is an electromagnetic proportional valve or combination of an electromagnetic proportional valve and pressure reducing valve, such that the requirement for compressed air intake can be easily realized when the engine works respectively at high speed, intermediate speed and low speed.

Preferably, the said controller system includes a high pressure common rail constant pressure pipe, a controller upper cover, a controller mid seat and a controller bottom base. The controller upper cover, the controller mid seat and the controller bottom base are connected removably and hermetically by bolts.

In another exemplary embodiment, the said sensor is an engine speed sensor, or an accelerator potentiometer or a combination of the both.

In another exemplary embodiment, the intake pipeline is placed in the said controller upper cover; the intake pipeline is connected to the high pressure common rail constant pressure pipe via threaded connection.

Furthermore, a controller intake valve, a controller valve spring and a controller valve seat are mounted in the said controller mid seat; the said controller valve is abutted against the controller valve seat under the pre-action of the controller valve spring.

Preferably, a controller tappet which controls the opening and closure of the controller valve is placed in the said controller bottom base, and the controller tappet is actuated by the intake camshaft.

In another embodiment, the number of the cylinders of the engine assembly is six, and the crankshafts include six unit bell cranks.

Preferably, the said six unit bell cranks are a first bell crank, a second bell crank, a third bell crank, a fourth bell crank, a fifth bell crank and a sixth bell crank individually, and the phase of each bell crank is set up as follows: the phase difference of the first bell crank and the second bell crank is 120 degrees, the phase difference of the second bell crank and the third bell crank is 120 degrees, the phase difference of the third bell crank and the fourth bell crank is 180 degrees, the phase difference of the fourth bell crank and the fifth bell crank is 120 degrees, the pase difference of the fifth bell crank and the sixth bell crank is −120 degrees.

According to another aspect of the present invention, a controller system used for an air-powered engine is provided. The controller system includes a high pressure common rail constant pressure pipe, a controller upper cover, a controller mid seat and a controller bottom base. The controller upper cover, the controller mid seat and the controller bottom base are connected by bolts removably and hermetically, and wherein an intake pipeline is placed in the said controller upper cover; the intake pipeline is connected to the high pressure common rail constant pressure pipe via threaded connection. The intake pipeline is communicated with a cavity of the high pressure common rail constant pressure pipe, so as to receive compressed air from the high pressure common rail constant pressure pipe.

In one embodiment of the present invention, a controller intake valve, a controller valve spring, an oil seal bush, a controller valve spring bottom base and a controller valve seat are mounted in the said controller mid seat. The said controller valve is abutted against the controller valve seat under the pre-action of the controller valve spring.

Furthermore, a controller tappet which controls the opening and closure of the controller valve is placed in the said controller bottom base, and the controller tappet is actuated by the intake camshaft. The intake camshaft is driven by the crankshaft through the crankshaft gear and gear idle of the front gear box, such that the controller tappet is driven to move when the engine works and further realizes opening and closure of the controller valve of the controller system.

Preferably, end covers of high pressure common rail constant pressure pipe are fixedly assembled on two ends of the high pressure common rail constant pressure pipe. More preferably, the said end cover has a projecting flange, the flange extends into the pipeline between high pressure intake speed control valve and high pressure common rail constant pressure pipe, and is fixedly connected to the high pressure pipeline removably by the means of threaded coupling.

According to another aspect of the present invention, many holes with different diameters are placed in the center of the controller mid seat, and they are a controller valve seat hole, a controller valve hole, an oil seal bush hole and a controller valve spring hole in turn from top to bottom, and wherein the diameter of the controller valve seat hole is larger than the diameter of the controller valve hole and the diameter of the oil seal bush hole. The diameter of the controller valve seat hole is larger than the diameter of the oil seal bush hole.

According to another aspect of the present invention, the controller valve hole is communicated with a gas throat hole connecting hole, so that when the controller valve is opened, the compressed air from the high pressure common rail constant pipe enters into the gas throat hole connecting hole through the branch intake pipeline.

Furthermore, the controller system of the present invention further includes an oil seal bush, the said oil seal bush is mounted in the oil seal bush hole and supported on the controller valve spring, and a valve stem of the controller valve passes through the interior of the oil seal bush.

Furthermore, the control valve spring is mounted in the controller valve spring hole, and its bottom end is supported on a controller valve spring bottom seat and fixed on the controller valve spring bottom seat by a controller valve lock jaw.

Through the controller system of the present invention, high pressure compressed air from a high pressure gas tank set can be effectively distributed to each cylinder of the engine, so as to realize continuous and reliable operation of the engine.

### BRIEF DESCRIPTION OF DRAWINGS

Preferred but not limited embodiments according to the present invention will be described. These and other characters, aspects and advantages of the present invention will be obvious when it is in detail described with reference to the drawings.

FIG. 1 is an overall schematic view of an air-powered engine assembly with a two-stroke engine in accordance with the present invention;

FIG. 2 is a front view of the engine body of the air-powered engine assembly with a two-stroke engine in FIG. 1;

FIG. 3 is a right side view of the engine body of the air-powered engine assembly with a two-stroke engine in FIG. 1;

FIG. 4 is a left side view of the engine body of the air-powered engine assembly with a two-stroke engine in FIG. 1;

FIG. 5 is a top view of the engine body of the air-powered engine assembly with a two-stroke engine in FIG. 1;

FIG. 6 illustrates a crankshaft-linkage-piston assembly of the engine body of the air-powered engine assembly with a two-stroke engine in FIG. 1, in which connection between one of the piston-linkage units and the cylinder body is shown;

FIG. 7 is a structural schematic view of a crankshaft unit of the crankshaft-linkage-piston assembly in FIG. 6;

FIG. 8 is a structural schematic view of a camshaft of the engine body in FIG. 2;

FIG. 9A is a perspective view of a controller system of the air-powered engine assembly with a two-stroke engine in FIG. 1;

FIG. 9B is a longitudinal sectional view of the controller system in FIG. 9A;

FIG. 9C is a transversal sectional view of the controller system;

FIG. 10A is a perspective view of a front gear box system of the air-powered engine assembly with a two-stroke engine in FIG. 1;

FIG. 10B is a left side view of FIG. 10A;

FIG. 10C is a partial sectional right side view of FIG. 10A;

FIG. 11A is a perspective view of a multiple-column power distributor of the air-powered engine assembly with a two-stroke engine in FIG. 1;

FIG. 11B is a transversal sectional view along a longitudinal sectional line in FIG. 11A;

FIG. 11C is a left side view of FIG. 11A; and

FIG. 11D is a top view of FIG. 11A.

### DETAILED EMBODIMENTS

The following description is exemplary only, and it is in no way to limit the disclosure, the application and the usage. It should be understood that the corresponding reference symbols indicate the same or corresponding components and characters throughout all drawings.

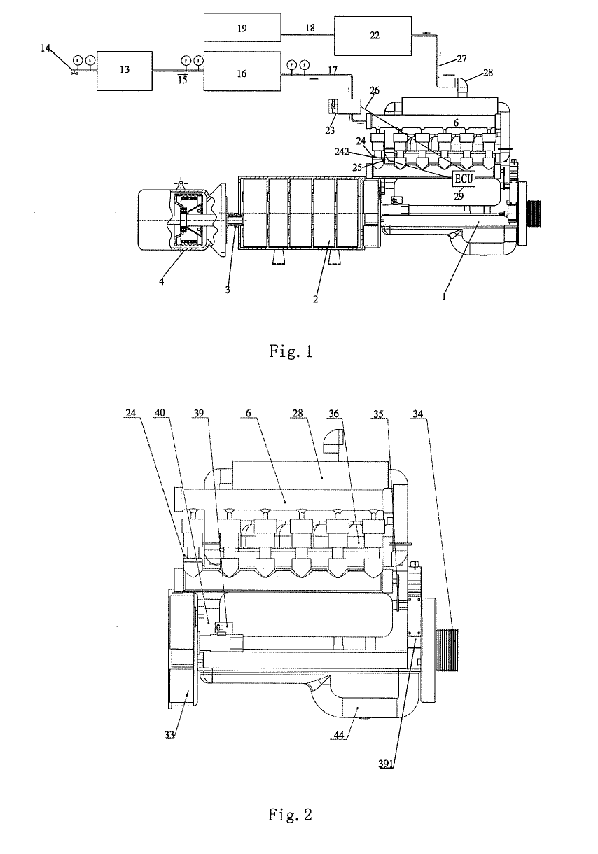

Now referring to FIG. 1, FIG. 1 is an overall schematic view of a two-stroke air-powered engine assembly in accordance with the present invention. Arrows in the figure show the flow direction of the air flow. In FIG. 1, the air-powered engine assembly includes an engine body 1, a multiple-column power distributor 2, a power equipment 4, a controller system 6, an air compressor 7, a condenser 11, an exhaust gas recycle tank 9, a high pressure gas tank set 13, a constant pressure tank 16, an intake speed control valve 23, an electro-drive turbine unidirectional suction pump 19, an electronic control unit ECU 29 and an impeller generator 22. As shown in FIG. 1, the high pressure air tank set 13 is connected to an external charge station or an external charge device via a compressed air intake pipeline 14 for receiving the requisite high pressure compressed air from an outside device. A flow meter A, a pressure meter P and a manual control switch (not shown) are placed on the compressed air intake pipeline 14. The flow meter A is adapted to measure and monitor the flow rate of the compressed air entering into the high pressure gas tank set 13, while the pressure meter P is adapted to measure and monitor the pressure of the compressed air entering into the high pressure gas tank set 13. When the high pressure gas tank set 13 needs to be charged through the external charge device or external charge station, the manual control switch is turned on, the high pressure compressed air enters into the high pressure gas tank set 13. When the readings of the flow meter A and the pressure meter P on the compressed air intake pipeline 14 reach the defined values, the manual control switch is turned off, and the charge procedure of the high pressure gas tank set 13 is finished. So the compressed air at the nominal pressure such as 30 MPa is acquired. In order to assure the safety of the gas tank, one or two or more safe valves (not shown) are placed on the high pressure gas tank set 13.

The high pressure gas tank set 13 may be made up of one or two or three or four or more high pressure gas tanks with enough volume in series or in parallel, and the number of the high pressure gas tanks of which the high pressure gas tank set 13 is made is determined on the basis of the actual demand in the application. The high pressure gas tank set 13 is connected to the constant pressure tank 16 via a pipeline 15, a flow meter A and a pressure meter P for monitoring and controlling the flow rate and the pressure of the compressed air are also placed on the pipeline 15. The constant pressure tank 16 is adapted to stabilize the pressure of the high pressure air from the high pressure gas tank set 13, and the pressure in the constant pressure tank 16 is slightly lower than the pressure in the high pressure gas tank set 13, such as between 21-28 MPa, preferably about 21 MPa. A pipeline 17 is placed between the constant pressure tank 16 and the intake speed control valve 23, and a flow meter A and a pressure meter P for monitoring and controlling the flow rate and the pressure of the compressed air are also placed on the pipeline 17. After controlled and adjusted by the intake speed control valve 23, the high pressure air from the constant pressure tank 16 enters into the controller system 6.

Now, the intake speed control valve 23 is described in detail. The function of the intake speed control valve 23 is to control the opening time of an electromagnetic valve on the basis of the command signal from the electronic control unit ECU 29 for determining the compressed air intake quantity. Because of the decompression function of the electromagnetic valve, the electromagnetic valve is combined with a decompression and pressure adjustment valve to form a speed control valve. Therefore, the rotary speed of the engine can be adjusted in a suitable range. The intake speed control valve 23 is controlled by the control signal 26 from the ECU 29. Many kinds of sensors are optionally placed in the engine body 1, such as a speed sensor for measuring the rotary speed of the engine, a position sensor for deciding the position of the top dead point of the cylinder, an accelerator potentiometer for deciding the position of an accelerating pedal and a temperature sensor for measuring the temperature of an engine block. In accordance with an exemplary embodiment of the present invention, a speed sensor 24 and/or an accelerator potentiometer 242 are shown. The speed sensor 24 may be a variety of speed sensors for measuring the rotary speed of the engine in the prior art, and generally it is placed on the crankshaft 56. The accelerator potentiometer 242 may be a variety of position sensors for measuring the position of the accelerating pedal in the prior art, and generally it is placed at the position of an accelerating pedal. When in a non-vehicle application, what is similar to the accelerator potentiometer of an accelerating pedal can be an engine load sensor, such as a torque sensor for monitoring the outputting torque of the engine, a position sensor of an electric current selector knob for controlling the generation current and so on. ECU 29 can calculate and send out a control signal 26 based on the various sensors' signals, such as a speed signal of the speed sensor 24 and/or a position signal of the accelerator potentiometer 242. The intake speed control valve is controlled by the control signal 26, so the intake speed control valve can meet the demand of high speed, middle speed or low speed, and the engine can rotate at high speed, middle speed or low speed accordingly.

The high pressure compressed air passing through the intake speed control valve flows into controller system 6 via a high pressure pipeline, and the high pressure compressed air is supplied to each cylinder of the engine by means of the controller system 6. The pressure is about 7-18 MPa for example, preferably 9-15 MPa, more preferably 11-13 MPa, so as to drive a piston 51 of the engine to reciprocate in a cylinder system 40 (as shown in FIGS. 2-6), and the reciprocating movement of the piston 51 can be converted to the rotary movement of the crankshaft 56 by means of the connecting rod 54, so the demands on every condition of the engine can be met. The special structure of the controller system 6 will be described later in detail.

With reference to FIG. 1 again, the rotary movement outputted from the engine body 1 is distributed to the power equipments, such as the generator 4, by means of the multiple-column power distributor 2. The multiple-column power distributor 2 can be connected with the flywheel on the crankshaft 56, and it can also be connected with crankshaft 56 by means of a connecting device such as a coupler, so as to transfer the power to the power equipment 4.

Because the air-powered engine of the present invention is driven directly by the high pressure air, the high pressure air drives the piston 51 to move during the crankshaft rotating 0-180 degrees. And when the piston continues to move upward due to the inertia after reaching the bottom dead point, the piston continues to rotate 180-360 degrees, and the engine operates in the discharge stroke. Now the discharged gas has a high pressure yet, such as about 3 MPa. On the one hand, the discharged gas with the high pressure is prone to form a high pressure exhaust gas flow when directly discharged into the atmosphere and bring about the exhaust gas noise. On the other hand, the energy contained by the compressed air is wasted. So an impeller generator 22 is provided in the present invention, such that the contained pressure energy of the exhaust gas can be utilized. As shown in FIG. 1, exhaust gas which is collected from the discharge header enters into the impeller generator 22 through the pipeline 27. The pressurized exhaust gas which enters into the impeller generator 22 drives the impeller generator 22 to generate electricity. Electricity generated by the impeller generator 22 is transmitted to a storage battery 19 by conducting wire 18 so as to be successively used for the engine.

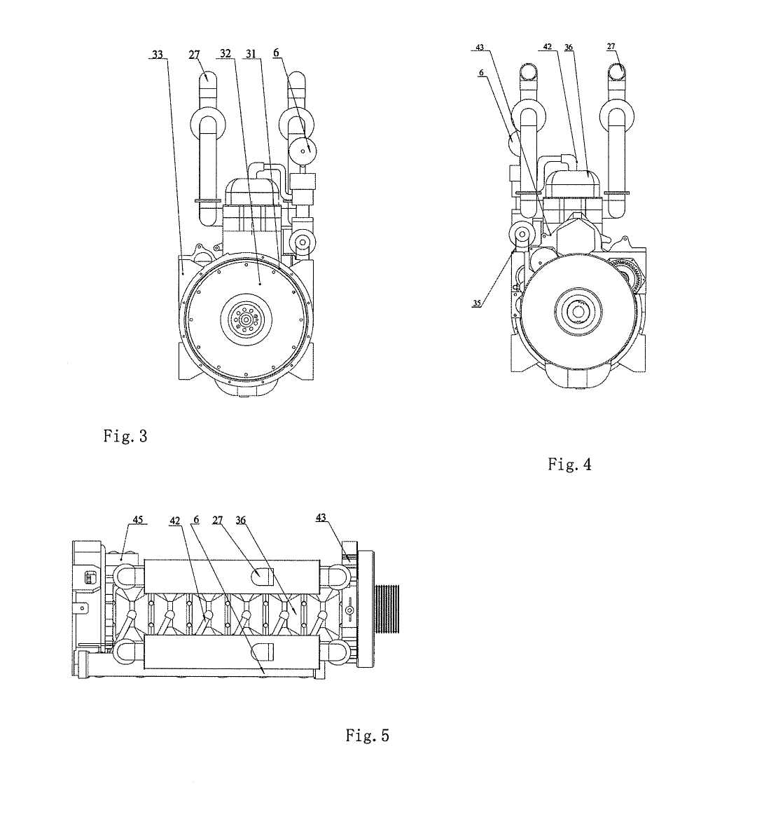

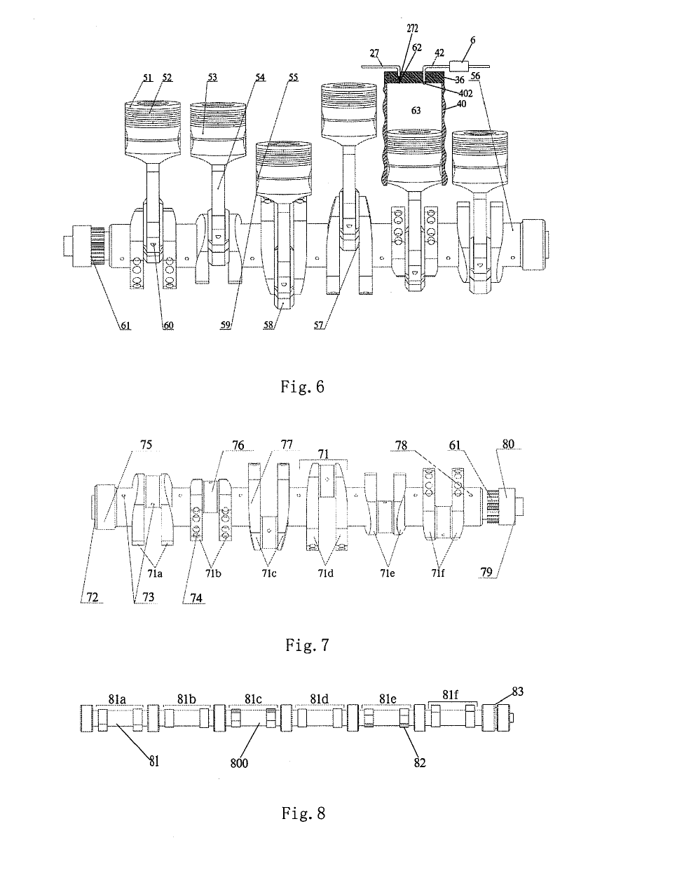

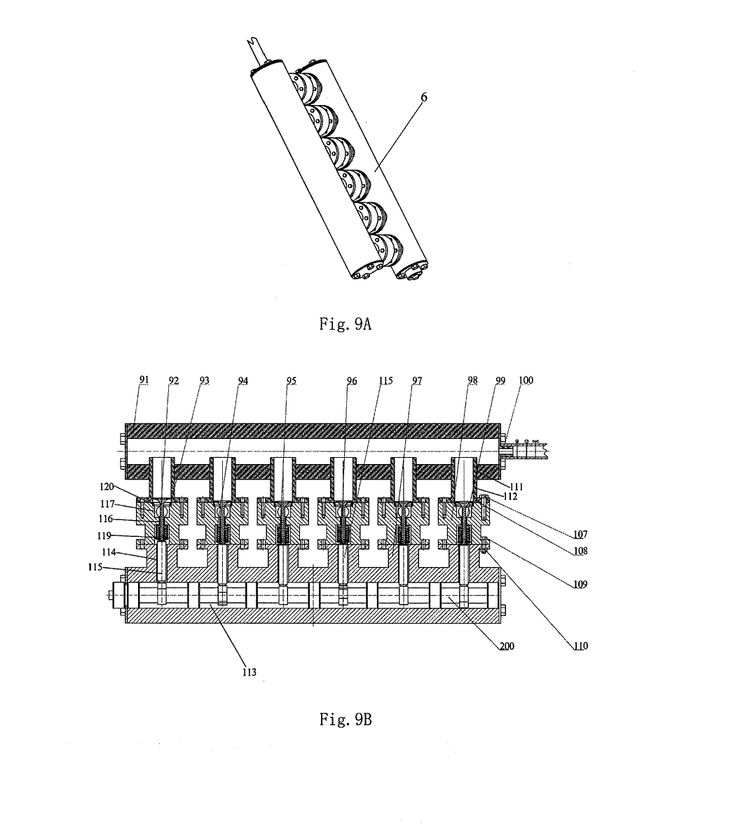

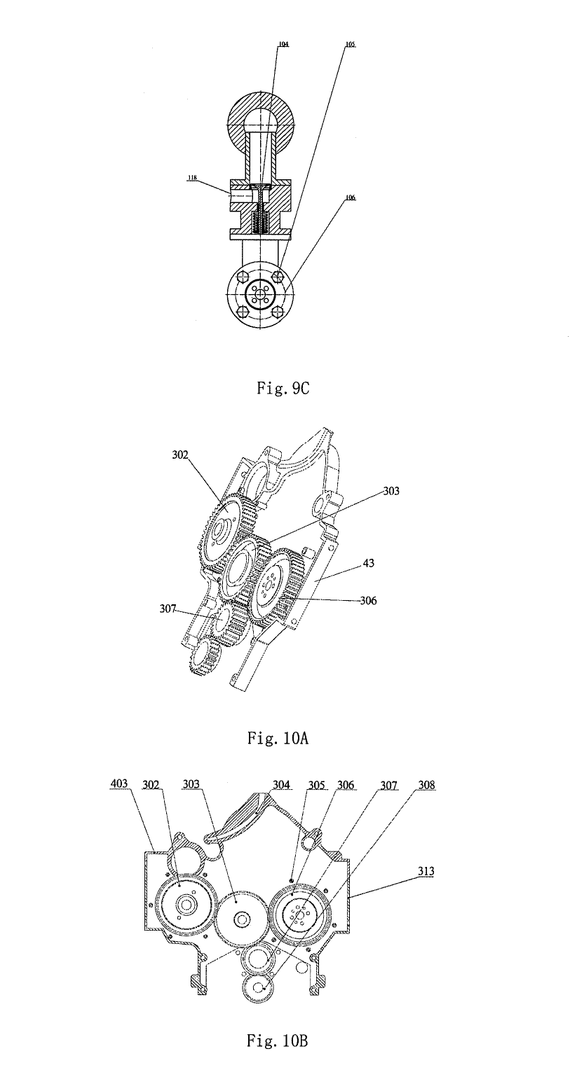

Now returning to FIGS. 2-5, FIGS. 2-5 illustrate the views of the engine body 1 in FIG. 1 from different view points. Wherein FIG. 2 is a front view of the engine body 1, FIG. 3 is a right side view of the engine body 1, FIG. 4 is a left side view of the engine body 1, and FIG. 5 is a top view of the engine body 1. With reference to FIG. 6, the engine body 1 includes the cylinder 40, a cylinder head system 36, the intake pipeline 42 (an intake valve throat), the discharge pipeline 27, the piston 51, the connecting rod 54, the crankshaft 56, a discharge camshaft 800 (as shown in FIG. 8), an intake camshaft 200 (which is mounted in an intake camshaft mounting hole 113 in FIG. 9), a front gear box system 43 and a back gear box 33. The front gear box system 43 is adapted to drive the crankshaft 56 and the camshaft. A gear ring 31 and a flywheel 32 which can be connected with the multiple-column power distributor 2 are positioned in the back gear box 33. In the exemplary embodiment of the engine body 1, an intake camshaft 200 and a discharge camshaft 800 are provided and connected to the crankshaft 56 by the front gear box system 43, and they can rotate suitably followed by the crankshaft 56. Because the drawed compressed air is controlled and distributed by the controller system 6 directly, the intake valve on the cylinder head system 36 of the engine is eliminated, and only the exhaust valve 62 is positioned thereon. In the exemplary embodiment, each cylinder has four exhaust valves, and the number of the exhaust valves can be one, two, four or six as required. The compressed air from the controller system 6 enters directly into the expansion and discharge chamber 63 through the valve throat 42 (see FIG. 6), and when the engine is working, the compressed air pushes the piston 51 to move downwards. The linear movement of the piston 51 is converted to the rotary movement of the crankshaft 56 by means of the connecting rod 54, and the output of the engine can be realized by the rotation of the crankshaft. After the piston 51 reaches the bottom dead point, the crankshaft 56 continues to move due to the inertia, and drives the piston 51 to move from the bottom dead point to the top dead point. Now, the discharge camshaft 800 can open the discharge valve 62 by means of the cam thereon and the corresponding rocker, and the discharge stroke is done. In the exemplary embodiment, the discharged exhaust gas preferably enters into the exhaust gas recycle loop.

A starter 39 for starting the engine, a generator 391 which is connected to the crankshaft by a connecting component such as a belt pulley, a cylinder block oil bottom house 44 for the oil return and an engine oil filter 2 for filtering the engine oil are placed on the engine body 1. The generator 391 may be for example an integral AC generator, a brushless AC generator, an AC generator with a pump or a permanent magnet generator and so on. When the engine works, the generator can supply power to the engine assembly and charge a battery cell or an accumulator cell (not shown in the figures).

Now referring to FIG. 6, the FIG. 6 illustrates the crankshaft-link-piston system of the engine body 1 of the two-stroke engine assembly in FIG. 1, wherein the connection of one piston-link unit and the cylinder 40 is shown. In the illustrative embodiment, there are six cylinders 40 preferably, and correspondingly there are six pistons 51 and six connecting rods 54. Alternatively, the numbers of the pistons 51, the cylinders 40 and the connecting rods 54 can be one, two, four, six, eight, twelve or the others as desired by the skilled in the art. Correspondingly, the crankshaft 56 must be designed matchedly for accommodating the number of the piston-link units. In the illustrative embodiment, as shown in the FIG. 6 and FIG. 7, preferably, the crankshaft 56 has six unit bell cranks, which corresponds with the preferable embodiment of the present invention. With reference to FIG. 6 again, in the shown connection of one piston-link unit and the cylinder 40, the high pressure compressed air from the controller system 6 enters into the expansion and discharge chamber 63 via the intake pipeline 41 through a gas throat hole 402 on the cylinder head 36. The high pressure gas expands in the expansion and discharge chamber 63 and does work, and pushes the piston 51 to move downwards, so it is the working stroke. The outputting work in the working stroke may be supplied outwards through the crankshaft and connecting rod system. When the piston 51 moves from the bottom dead point to the top dead point in the cylinder, the discharge valve 62 is opened, the air under a pressure is discharged from the expansion and discharge chamber via the discharge pipeline 27, and which is the discharge stroke. Immediately before the piston reaches the top dead point, the discharge valve 62 is closed, the controller system 6 starts to supply the air to the expansion and discharge chamber 63, and the next cycle begins. Obviously, the engine does work once when the crankshaft 56 of the engine of the present invention rotates one round (360 degrees), and it isn't similar to the traditional four-stroke engine wherein the crankshaft could complete the whole strokes of the intake, the compression, the expansion and the discharge once when rotating two rounds (720 degrees). The present invention is similar to the two-stroke engine, but it is different from the traditional two-stroke engine because an intake port is positioned generally at the bottom of the cylinder in the traditional two-stroke engine, and a scavenging port and a discharge port are placed at a suitable position in the cylinder. In the two-stroke engine of the present invention, the gas throat hole 402 for the intake of the high pressure compressed air and a discharge port 272 are placed on the top of the cylinder, and the opening and closure of the gas throat hole 402 is executed by the intake camshaft 200 via the controller system 6, and the opening and closure of the discharge port is executed by the opening and closure of the discharge valve 62 controlled by the rocker, in which the rocker is actuated by the discharge camshaft 800 which is driven by the crankshaft. So the two-stroke engine of the present invention is fully different from the traditional two-stroke engine; it utilizes effectively the high pressure air which can expand and do work directly, and the piston 51 does work once when the crankshaft 56 rotates one round (360 degrees). So the engine of the present invention can multiply the power one time in comparison with the traditional four-stroke engine in condition of the same air displacement.

Now with reference to FIG. 5 and FIG. 6, the crankshaft includes a gear connecting bolt 79, a leading end 80 of the crankshaft, a bevel gear 61, a main journal 78, a unit bell crank 71, a balance weight 77, a crank pin 76, a trailing end 75 of the crankshaft and a flywheel connecting bolt 72. One or more engine oil holes for supplying engine oil to the crankshaft are respectively provided on the main journal 78 and the crank pin 76 on the crankshaft 56. The gear connecting bolt 79 for connecting with the corresponding gear in the front gear box system 43 is placed on the right (as shown direction in the figures) of the leading end 80 of the crankshaft and at an adjacent position. The bevel gear 61 for driving the camshaft to rotate is placed on the left (as shown direction in the figures) of the leading end 80 of the crankshaft and at an adjacent position. The flywheel connecting bolt 72 for fixedly connecting with the flywheel 32 is placed at the outside of the trailing end 75 of the crankshaft and at an adjacent position. One or two or more balance weight holes for adjusting the balance are placed on the balance weight 77. In the preferred embodiment of the present invention, the unit bell cranks 71 of the crankshaft include six unit bell cranks, i.e., a first unit bell crank 71a, a second unit bell crank 71b, a third unit bell crank 71c, a fourth unit bell crank 71d, a fifth unit bell crank 71e and a sixth unit bell crank 71f. They are corresponding to first to sixth connecting rod 54 or piston 51. Alternatively, the number of the unit bell cranks 71 may be variable, such as one, two, four, six, eight or more as the skilled in the art know easily. In the preferred embodiment in the FIG. 6 and FIG. 7, the phase of each bell crank is set up as follows: the phase difference of the first bell crank 71a and the second bell crank 71b is 120 degrees, the phase difference of the second bell crank 71b and the third bell crank 71c is 120 degrees, the phase difference of the third bell crank 71c and the fourth bell crank 71d is 180 degrees, the phase difference of the fourth bell crank 71d and the fifth bell crank 71e is −120 degrees, the phase difference of the fifth bell crank 71e and the sixth bell crank 71f is −120 degrees. So the operation sequence of the unit bell crank is set up as follows: the first and the fifth unit bell crank work at the same time, then the third and the sixth unit bell crank work together, and at last the second and the fourth unit bell crank work together. So the operation sequence of the cylinders of the engine is set up as follows: 1-5 cylinders, 3-6 cylinders and 2-4 cylinders. In the teaching of the present invention, the unit bell crank and their phase differences and operation sequence which are different from that of the present invention can be set up by the skilled in the art, and which would fall in the scope of the present invention.

With reference to FIG. 6, the piston 51 is connected to the crankshaft 56 by the connecting rod 54. The connecting rod 54 includes a small end of the link, a link body and a big end of the link. The big end of the link includes a link cover 58, a circular space is formed in the link cover 58, so that the link cover 58 is connected to the crank pin 76 of the crankshaft by a bearing bush 57 of the link in the space. An oil stop ring 53 made from tetrafluoroethylene and a piston ring 53 made from tetrafluoroethylene are placed on the peripheral surface of the piston 51. In the illustrative embodiment, four oil piston rings 52 made from tetrafluoroethylene and two stop rings 53 made from tetrafluoroethylene are placed on each piston 51. Alternatively, the numbers of the oil stop rings 53 made from tetrafluoroethylene and the piston rings 53 made from tetrafluoroethylene can be two, three, four or more. The oil stop rings 53 made from tetrafluoroethylene have the function of stopping the oil, the piston rings 53 made from tetrafluoroethylene have the function of scraping off the oil, and they function together to assure the reliable lubrication and seal of the lubricant oil.

Now with reference to FIG. 8, FIG. 8 illustrates a structural schematic view of the discharge camshaft 800 of the engine body 1 in FIG. 2. The discharge camshaft 800 includes a unit cam 81 and a sprocket wheel 83. In the illustrative embodiment, the unit cams 81 include six unit cams, i.e., a first unit cam 81a, a second unit cam 81b, a third unit cam 81c, a fourth unit cam 81d, a fifth unit cam 81e and a sixth unit cam 81f. Alternatively, the number of the unit cams 81 can be one, two, four, six, eight, twelve or more, and it is dependent on the number of the cylinders of the engine and the number of the discharge valves in each cylinder. In the illustrative embodiment of the present invention, each unit cam 81 includes two cams 82, and each cam 82 can control the opening of the corresponding discharge valve 62. In the preferred embodiment in FIG. 8, the phases of each cam 81 are set up as follows: the phase difference of the first unit cam 81a and the second unit cam 81b is 120 degrees, the phase difference of the second unit cam 81b and the third unit cam 81c is 120 degrees, the phase difference of the third unit cam 81c and the fourth unit cam 81d is 180 degrees, the phase difference of the fourth unit cam 81d and the fifth unit cam 81e is −120 degrees, the phase difference of the fifth unit cam 81e and the sixth unit cam 81f is −120 degrees. So the operation sequence of the unit cams is set up as follows: the first and the fifth unit cams work at the same time, then the third and the sixth unit cams work together, and at last the second and the fourth unit cams work together. So the operation sequence of the cylinders of the engine is set up as follows: 1-5 cylinders, 3-6 cylinders and 2-4 cylinders. In the teaching of the present invention, the unit cams and their phase differences and operation sequence which are different from that of the present invention can be set up by the skilled in the art, and which would fall in the scope of the present invention.

Now with reference to FIG. 9, FIG. 9A-FIG. 9B are referred to as FIG. 9 together, and they are views of the controller system 6 of the two-stroke air-powered engine assembly in FIG. 1. As shown in FIG. 9, the controller system 6 includes a high pressure common rail constant pressure pipe 91, a controller bottom base 97, a controller mid seat 89, a controller valve 92, a controller spring 94 and a controller upper cover 108. The high pressure common rail constant pressure pipe 91 has a cylindrical shape, but may be rectangular, triangular etc. The interior of the high pressure common rail constant pressure pipe 91 is a cylindrical channel, for example, for receiving the high pressure intake gas from the intake speed control valve 23, and the pressure of the compressed air in the channel is generally kept balanced, so that the high pressure air initially entering into the expansion and discharge chamber 63 of each cylinder 40 is under the same pressure, which makes the engine stably work. End covers 100 of the high pressure common rail constant pressure pipe are fixedly assembled on two ends of the high pressure common rail constant pressure pipe 91, and the end cover 100 connecting to the intake speed control valve 23 has a projecting flange (not marked in the figures). The flange extends into a pipeline between the high pressure intake speed control valve 23 and the high pressure common rail constant pressure pipe 91, and is fixedly connected to the high pressure pipeline removably by the means of threaded coupling for example. The end covers 100 of the high pressure common rail constant pressure pipe are connected to the high pressure common rail constant pressure pipe 91 by end cover connecting bolts. Upper cover connecting holes 111 whose number is corresponding to that of the cylinders are placed on the high pressure common rail constant pressure pipe, and in the illustrative preferred embodiment, the number of the upper cover connecting holes 111 is six. The cross sectional shape of the controller upper cover 108 along the central line thereof is an inverted T-shape. There are a cylindrical branch intake pipeline 112 and a circular under surface (not marked in the figures). The branch intake pipeline 112 is connected in the upper cover connecting hole 111 by means of a male thread on the top end thereof, so it is fixedly connected to the high pressure common rail constant pressure pipe 91 removably. The controller upper cover 108 is fixedly connected to the controller mid seat 98 hermetically and removably by connecting bolts of the upper cover and the mid seat or other fastener. The controller mid seat is fixedly connected to the controller bottom base 97 hermetically and removably by connecting bolts 110 of the mid seat and the bottom base or other fastener.

As shown in FIG. 9, many holes with different diameters are placed in the center of the controller mid seat 98, and they are a controller valve seat hole 120, a controller valve hole 117, an oil seal bush hole 116 and a controller valve spring hole 119 in turn from top to bottom. In the illustrative embodiment, the diameter of the hole 120 is larger than the diameter of the hole 117 and the diameter of the hole 116. The diameter of the hole 117 is larger than the diameter of the hole 116. The diameter of the hole 119 may or may not be the same of the hole 117, but it is larger than the diameter of the hole 116. In a preferred embodiment, the diameter of the hole 119 is equal to the diameter of the hole 117, but a little smaller than the diameter of the hole 120. The controller valve seat is mounted in the controller valve seat hole 120 and supported on the controller valve hole 117. The controller valve hole 117 is a hollow cavity, and it is communicated with a gas throat hole connecting hole 118, so that when the controller valve is opened, the compressed air from the high pressure common rail constant pipe 91 enters into the gas throat hole connecting hole 118 through the branch intake pipeline 112. One end of the gas throat hole connecting hole 118 is communicated with the controller valve hole 117, the other end of the gas throat hole connecting hole is communicated with the gas throat hole 402 of the cylinder head system 36, and the hole is kept normally open, so that when the controller valve 92 is opened, the compressed air is sent to the expansion and discharge chamber 63 and drives the engine to do work. An oil seal bush 99 is mounted in the oil seal bush hole 116 and supported on the controller valve spring 94, and a valve stem (not marked in the figures) of the controller valve 92 passes through the interior of the oil seal bush 99. The oil seal bush 99 has the function of guiding the valve stem besides the function of sealing the controller valve 92. The control valve spring 94 is mounted in the controller valve spring hole 119, and its bottom end is supported on a controller valve spring bottom seat 95 and fixed on the controller valve spring bottom seat 95 by a controller valve lock jaw. When the engine does not work, the controller valve spring 94 is preloaded with a pre-tension, which pushes the controller valve 92 against the controller valve seat 93, and the controller valve 92 is closed.

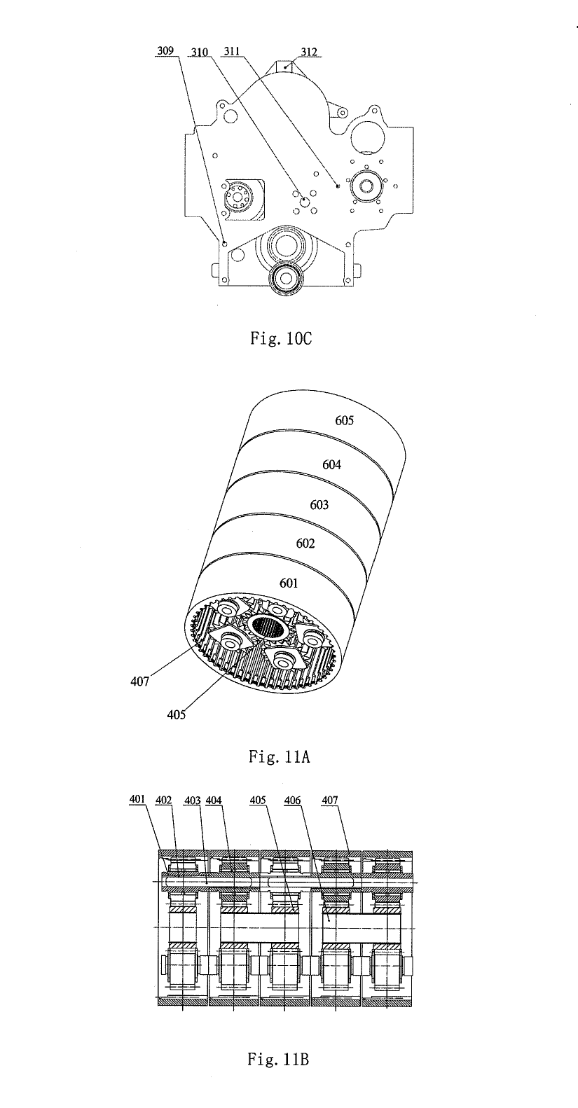

Six illustrative controller tappet mounting holes 114 are provided in the controller bottom base 97, and a variable number of controller tappet mounting holes 114 can be set up on the basis of the number of the cylinders of the engine, such as one, two, four, six, eight, ten or more. The controller tappet 115 is mounted in the controller tappet mounting hole 114, and follows along with the rotation of the intake camshaft 200 mounted in the intake camshaft mounting hole 113 to reciprocate up and down. When the cylinder 40 of the engine needs to be supplied with the high pressure compressed air, the controller tappet 115 is jacked up by the cam of the intake cam shaft 200, and then the controller tappet 115 jacks up the valve stem of the controller valve 92, so that the valve stem overcomes the drag force of the controller valve spring 94 and moves away from the controller valve seat 93. Thus, the controller valve is opened, the high pressure compressed air enters into the expansion and discharge chamber 63 through the high pressure common rail constant pressure pipe 91 to meet the need of gas supply of the engine. After the intake camshaft 200 rotates through an angle along with the crankshaft 56, the valve stem of the controller valve 92 is repositioned on the controller valve seat 93 under the restoring reaction of the controller valve spring 94, then the controller valve 92 is closed, and the air supply is finished. Because the air-powered engine of the present invention is a two-stroke engine, the controller valve 92 and the discharge valve 62 each is opened and closed once when the crankshaft 56 rotates one round, so that the cam phases of the intake camshaft 200 and the discharge camshaft 800 and their connection relation with the crankshaft are set up easily. The detailed structure and movement transmission is illustrated in FIG. 10.

Now with reference to FIG. 10, FIG. 10A-FIG. 10C are referred to as FIG. 10 together, and they are different views of the front gear box system 43 of the two-stroke air-powered engine assembly in FIG. 1. As shown in FIG. 10, the front gear box system includes a polygonal cover 313, a transmission gear 308, a crankshaft gear 307, a bridge gear 303, an intake camshaft gear 302 and a discharge camshaft gear 306. The camshaft gear 307 is fixedly connected to one end of the crankshaft 56 passing through the polygonal cover 313, so that the rotation is transmitted from the crankshaft. The transmission gear 308, which is an engine oil pump gear, for example, is provided under the crankshaft gear 307 (the orientation shown in FIG. 10B), so as to drive the component of the engine oil pump to rotate by means of the transmission gear 308. The intake camshaft gear 302, the bridge gear 303 and the discharge camshaft gear 306 are provided above the crankshaft gear 307 in turn from left to right (the orientation shown in FIG. 10B). The crankshaft gear 307 is engaged with the bridge gear 303 to drive the bridge gear 303 to rotate. The bridge gear 303 is engaged with the intake camshaft gear 302 and the discharge camshaft gear 306 on the left side and the right side simultaneously, so that the intake camshaft gear 302 and the discharge camshaft gear 306 are driven to rotate via the crankshaft gear 307 and the bridge gear 303 when the crankshaft 56 rotates, which causes the intake camshaft 200 and the discharge camshaft 800 to rotate, and ultimately the opening and the closure of the intake valve 62 and the controller valve 92 are realized. In the illustrative embodiment, the discharge camshaft gear 306 is fixedly connected to the discharge camshaft 800 directly, so the rotation of the discharge camshaft gear 306 directly makes the discharge camshaft 800 rotate. A belt pulley (not shown) is fixed in a suitable position on the central shaft of the intake camshaft gear 302. The belt pulley is connected to a belt pulley provided on the intake camshaft 200 by a camshaft transmission belt 35, so the intake camshaft 200 is driven to rotate, and the opening and the closure of the controller valve 92 are realized. Alternatively, a sprocket wheel (not shown) may also be fixed in a suitable position on the central shaft of the intake camshaft gear 302. The sprocket wheel is connected to a sprocket wheel provided on the intake camshaft 200 by a chain, so the intake camshaft 200 is driven to rotate, and the opening and the closure of the controller valve 92 are realized.

Many holes for different functions are provided in the polygonal cover 313, such as screw connecting holes 309, screw holes 310 and bolt connecting holes 311. The polygonal cover 313 is connected to the engine block via the screw connecting holes 309, and the bridge gear 303 is connected to the polygonal cover 313 via the screw holes 310, and the bolt connecting holes 311 are used to connect the polygonal cover 311 with the engine block. The bolt connecting holes 311 may be welded in a welding post 5 on the polygonal cover 311. An oil hole 304 for the lubricant oil flow and a hoisting ring base are also provided in the polygonal cover 311.

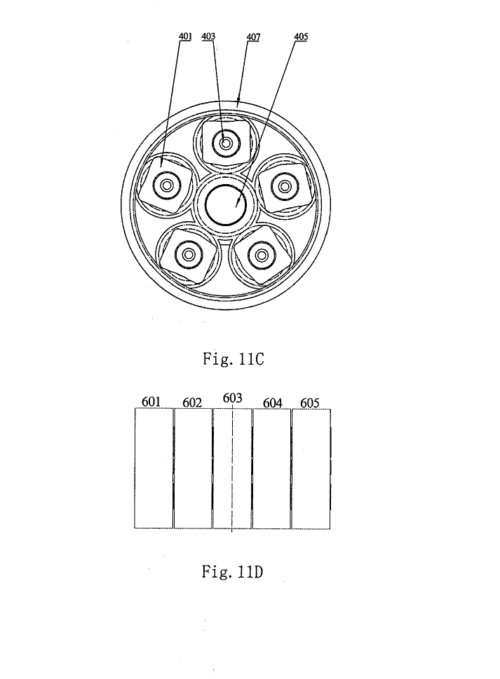

Now with reference to FIG. 11, FIG. 11A-FIG. 11C are referred to as FIG. 11 together, and they are different views of the multiple-column power distributor 2 of the two-stroke air-powered engine assembly in FIG. 1. As shown in FIG. 11, in the illustrative embodiment of the present invention, the multiple-column power distributor 2 is a multiple-stage power distributor, and it is made up of a first stage 601, a second stage 602, a third stage 603, a fourth stage 604 and a fifth stage 605 (from left to right shown in FIG. 10B). Alternatively, the multiple-column power distributor may be made up of the stages other than five stages in the embodiment, such as three stages, four stages, six stages or seven stages. The structure of every stage is the same in general, and each stage includes a planetary gear 401, an inner gear ring 407 and a sun gear 405. The number of the planetary gears 401 in every stage can set up equally, such as three, five, seven or more. In the illustrative embodiment, each stage includes five planetary gears 401 distributed uniformly. The benefit thereof is that the load of the main shaft is distributed uniformly because of the uniform distribution of the planetary gear, and the transmission can be stable and the transmission power is high. As shown in FIG. 11B, the planetary gears 401 of the first stage 601 and the second stage 602 are connected by a planetary gear pin 403, so that the first stage 601 and the second stage 602 rotate synchronously. The planetary gear pin 403 is connected to the planetary gear 401 by a smooth flat key 4021 or a spline. In the illustrative embodiment, the planetary gear pin 403 may be a slender cylindrical pin, and its shape also may be rectangular, trapezoidal and semicircular, and the number of the pins in every stage may be two, three, four, five or more. The sun gears of the second stage 602 and the third stage 603 is connected by a sun gear pin 406, so the united movement of the second stage 602 and the third stage 603 is realized. The connection relation of the third stage 603 and the fourth stage 604 is similar to the connection relation in the first stage 601 and the second stage 602, the connection relation of the fourth stage 604 and the fifth stage 605 is similar to the connection relation of the second stage 602 and the third stage 603. As such, the power transmission from the first stage 602 to the fifth stage 603 of the multiple-column power distributor 4 is realized, and the power inputted from the first stage 601 may be outputted from the fifth stage 605. Particularly, the planetary gear 401 in every stage only spins around itself axis, and it does not revolve about the corresponding sun gear 405, so the inner structure of the multiple-column power distributor is simple and is easy to transmit power stably. Now the operating principle of the multiple-column power distributor 2 is described. The flywheel 32 is placed on the crankshaft 51 of the engine body 1, the gear ring 31 is fixed on the periphery of the flywheel 32, and the gear ring 31 has an outer gear ring which is engaged with the inner gear ring 407 with inner teeth on the first stage 601 of multiple-column power distributor 2 so as to transmit the movement of the crankshaft 56 to the inner gear ring 407 of the first stage 601. The planetary gear 401 of the first stage 601 is connected to the planetary gear of the second stage 602, the power is transmitted from the first stage 601 to the second stage 602, and the planetary gear 401 of the second stage 602 drives the sun gear of the second stage to rotate. The sun gear 405 of the second stage is connected to the sun gear of the third stage by a sun gear pin 406 and drives the sun gear 405 of the third stage to rotate, and the power is transmitted from the second stage 602 to the third stage 603. Being similar to the first stage 601, the third stage 603 transmits the power from the third stage 603 to the fourth stage 604 through the planetary gear 401. Being similar to the second stage, the fourth stage transmits the power from the fourth stage to the fifth stage through the sun gear 405. In the illustrative embodiment of the present invention, the rotary shaft of the planetary gear of the fifth stage 605 is the output end, the power is divided into many branches (in the illustrative embodiment, two branches) and transmitted to an element connected to the multiple-column power distributor 2. For example, in the illustrative embodiment of the present invention, the element is the power unit 4 of the generator. So the power is outputted from the crankshaft 56 of the engine, and multiple-branch output is realized by the multiple-column power distributor 2. By comparison with the gear box of the traditional engine, five stages of the planetary gear are used to transmit power and re-distribute, so it could save labor and reduce the torque vibration during the transmission.

The present invention is disclosed in detail in the description which includes the preferred embodiments and makes the skill in the art be able to perform the present invention, which includes the manufacture and utilization of any equipment or system and the introduced process. The claimed scope is defined by the additional claims, and the present invention can be modified, varied or altered without deviation from the scope and spirit of the present invention.

1. A two-stroke air-powered engine assembly, which comprises: an engine body (1), which the body includes a cylinder (40), a cylinder head system (36), an intake pipeline (42), a discharge pipeline (27), a piston (51), a connecting rod (54), a crankshaft (56), a discharge camshaft (800), an intake camshaft (200), a front gear box system (43) and a back gear box (33); said piston (51) being connected to the crankshaft (56) via the connecting rod (54); said front gear box system (43) being adapted to transmit the movement of the crankshaft (56) and the discharge and intake camshafts (800,200); an air throat hole (402) for a compressed air intake and a discharge hole (272) for an exhaust gas discharge being provided on said cylinder head system (36); a high pressure gas tank set (13) which is connected to an external charge device via a pipeline (14), characterized in that said two-stroke air-powered engine assembly also includes a constant pressure tank (16) which is connected to the high pressure gas tank set (13) via a pipeline (15); an intake speed control valve (23) which is communicated with the constant pressure tank (16) via a pipeline (17); a controller system (6), and an electronic control unit ECO (29) which controls the intake speed control valve (23) on the basis of the detected signal of a sensor (24,242); said front gear box system includes a polygonal cover (313), a transmission gear (308), a crankshaft gear (307), a gear idle (303), an intake camshaft gear (302), a discharge camshaft gear (306); the movement from the crankshaft (56) is transmitted by the crankshaft gear (307) through the gear idle (303) to the intake camshaft gear (302) which drives the intake camshaft (200) and the discharge camshaft gear (306) which drives the discharge camshaft (800).

2. The engine assembly according to claim 1, characterized in that said engine assembly further includes a multiple-column power distributor (2), said multiple-column power distributor (2) including five stages, and being made up of a first stage (601), a second stage (602), a third stage (603), a fourth stage (604) and a fifth stage (605), each stage including an inner gear ring (407), a planetary gear (401) and a sun gear (405).

3. The engine assembly according to claim 1, characterized in that said controller system (6) includes a high pressure common rail constant pressure pipe (91), a controller upper cover (108), a controller mid seat (98) and a controller bottom base (97); said controller upper cover (108), said controller mid seat (98) and said controller bottom base are connected by bolts removably and hermetically.

4. The engine assembly according to claim 3, characterized in that an intake pipeline (112) is provided in the said controller upper cover (108), the intake pipeline (112) being connected to the high pressure common rail constant pressure pipe via a threaded connection; a controller intake valve (92), a controller valve spring (94), an oil seal bush (99), a controller valve spring bottom base (97) and a controller valve seat (93) are mounted in said controller mid seat (98), said controller valve (92) being abutted against the controller valve seat (93) under the pre-action of the controller valve spring (94); a controller tappet (115) which controls the opening and closure of the controller valve (92) is provided in the said controller valve spring bottom base (97), and the controller tappet (115) is actuated by the intake camshaft (200).

5. The engine assembly according to claim 1, characterized in that the number of the cylinders (40) of the engine assembly is six, and the crankshafts (56) include six unit bell cranks (71).

6. The engine assembly according to claim 5, characterized in that said six unit bell cranks are a first bell crank (71a), a second bell crank (71b), a third bell crank (71c), a fourth bell crank (71d), a fifth bell crank (71e) and a sixth bell crank (71f) individually, and a phase of each bell crank is set up as follows: a phase difference of the first bell crank (71a) and the second bell crank (71b) being 120 degrees, a phase difference of the second bell crank (71b) and the third bell crank (71c) being 120 degrees, a phase difference of the third bell crank (71c) and the fourth bell crank (71d) being 180 degrees, a phase difference of the fourth bell crank (71d) and the fifth bell crank (71e) being −120 degrees, and a phase difference of the fifth bell crank (71e) and the sixth bell crank (71f) being −120 degrees.

7. A controller system used for an air-powered engine, said controller system including a high pressure common rail constant pressure pipe (91), a controller upper cover (108), a controller mid seat (98) and a controller bottom base (97), characterized in that said controller upper cover (108), said controller mid seat (98) and said controller bottom base are connected by a plurality of bolts removably and hermetically, and wherein an intake pipeline (112) is provided in said controller upper cover (108); said intake pipeline (112) being connected to the high pressure common rail constant pressure pipe (91) via a threaded connection, said intake pipeline (112) being communicated with a cavity of the high pressure common rail constant pressure pipe so as to receive compressed air from the high pressure common rail constant pressure pipe.

8. The controller system according to claim 7, characterized in that a controller intake valve (92), a controller valve spring (94), an oil seal bush (99), a controller valve spring bottom base (97) and a controller valve seat (93) are mounted in said controller mid seat (98), said controller valve (92) being abutted against the controller valve seat (93) under the pre-action of the controller valve spring (94).

9. The controller system according to claim 7, characterized in that a controller tappet (115) which controls the opening and closure of the controller valve (92) is provided in said controller valve spring bottom base (97), and the controller tappet (115) is actuated by the intake camshaft (200) so as to receive the movement from the intake camshaft (200).

10. The controller system according to claim 7, characterized in that a plurality of holes with different diameters are provided in a center of the controller mid seat (98), which being a controller valve seating hole (12), a controller valve hole (117), an oil seal bush hole (116) and a controller valve spring hole (119) in turn from top to bottom, and wherein the diameter of a controller valve seathole (120) is larger than the diameter of the controller valve hole (117) and the diameter of the oil seal bush hole (116), the diameter of the controller valve seat hole (117) being larger than the diameter of the oil seal bush hole (116).

11. The controller system according to claim 10, characterized in that said controller valve hole (117) is communicated with a gas throat hole connecting hole (118), so that when the controller intake valve (92) is opening, the compressed air from the high pressure common rail constant pipe (91) enters into the gas throat hole connecting hole (118) through the intake pipeline (112).

12. The controller system according to claim 7, characterized in that said controller system further includes an oil seal bush (99), said oil seal bush (99) being mounted in the oil seal bush hole (116) and supported on the controller valve spring (94), and a valve stem of the controller intake valve (92) passing through an interior of the oil seal bush.

13. The controller system according to claim 7, characterized in that said control valve spring (94) is mounted in the controller valve spring hole (119), and its bottom end is supported on a controller valve spring bottom seat (95) and fixed on the controller valve spring bottom seat (95) by a controller valve lock jaw (96).
